(19) United States
(12) Patent Application Publication
(10) Pub. No.: US 2008/0251556 A1
(43) Pub. Date: Oct. 16, 2008

(54) Vehicle hitch assembly for suspension support of an accessory

(76) Inventor: Bradley V. Ayers, Pittsburgh, PA (US)

Correspondence Address: FLOYD B. CAROTHERS;CAROTHERS AND CAROTHERS, 445 FORT PITT BOULEVARD, SUITE 200, PITTSBURGH, PA, 15219, US

(21) Appl. No.: 11/880,019

(22) Filed: Jul. 19, 2007

Related U.S. Application Data
(60) Provisional application No. 60/922,723, filed on Apr. 10, 2007.
(60) Provisional application No. 60/931,859, filed on May 26, 2007.
(60) Provisional application No. 60/933,009, filed on Jun. 4, 2007.

(51) Int. Cl. B60R 9/06

(52) U.S. Cl. 224/521

(57) ABSTRACT

A vehicle hitch assembly for suspension support of an accessory from the rear of a vehicle having a rear bumper and a trailer hitch receiver positioned under the bumper. The hitch assembly includes a horizontally extending rigid trailer hitch receiver insert for insertion and retention in the vehicle trailer hitch receiver, and a rigid support arm having one end detachably securable to the vehicle rear bumper and another end thereof rigidly securable to the trailer hitch receiver insert. An accessory support is then secured to the vehicle hitch assembly for supporting a load off of the rear of the vehicle.

### CROSS REFERENCE

This application claims the benefit of the following U.S. Provisional Patent Applications, the contents of which are incorporated herein by reference:
Application No. 60/922,723, filed Apr. 10, 2007;
Application No. 60/931,859, filed May 26, 2007; and
Application No. 60/933,009, filed Jun. 4, 2007.

### BACKGROUND OF THE INVENTION

The present invention relates to a vehicle hitch assembly for suspension support ofan accessory from the rear of a vehicle.

Present day pickup trucks and sport utility vehicles are often provided with a Class III or Class IV trailer hitch which has a horizontal box receiver positioned below the rear bumper of the vehicle. Instead of towing a trailer it is common practice to support a rack or accessory support in suspension from this hitch receiver to support an accessory in suspension offthe rear of the vehicle, such as a rack to support a lawn tractor, spreader or a motorcycle, or a platform supporting luggage, equipment or containers, or for supporting a boom, crane or lift. For example, see Liscinsky, U.S. Pat. No. 5,310,100, issued May 10, 1994, for CARRIER FOR MOUNTING ON VEHICLE HTICH.

The problem encountered with such carriers is that the trailer hitch receivers are designed to handle the tongue weight of a trailer and the pushing and pulling stresses oftowing a trailer. They are not designed for excessively heavy torque loads applied downwardly on the hitch receiver imposed by heavy loads supported in suspension on a rack or platform supported from the receiver hitch.

U.S. Pat. No. 6,148,928, issued on Nov. 21, 2000 to Spears, discloses a hitch assembly which attaches to a pickup truck and which attempts to eliminate or reduce this problem. This hitch assembly supports a 3 point hitch from the rear of the pickup truck by supporting the device in suspension not only from the hitch receiver of a Class III or Class IV hitch, but in addition, further supports the load from a goose neck hitch mounted in the center of the truck bed above the rear axle of the truck. However, the problem here encountered is that the pickup truck bed cannot otherwise be utilized in its intended manner for accommodating a load, and in addition, the pickup truck tailgate cannot be used in its normal intended manner. This also holds true for sport utility vehicles and vans as such a hitch assembly would interfere with the normal use of the cargo area and the tailgate or lift back.

It is a principal object of the present invention to provide a hitch assembly for suspension support of an article from the rear of a vehicle which eliminates these aforementioned deficiencies and provides adequate support for supporting heavy loads from the rear of the vehicle in suspension.

### SUMMARY OF THE INVENTION

The vehicle hitch assembly of the present invention is provided for suspension support of an accessory from the rear of a vehicle of any type having a rear bumper and a trailer hitch receiver positioned under the bumper. The vehicle hitch assembly of the present invention is comprised of a horizontally extending rigid trailer hitch receiver insert for insertion and retention into the trailer hitch receiver, and a rigid support arm having one end detachably secured to the vehicle rear bumper and the other end thereof secured to the trailer hitch receiver insert. An accessory support, such as a platform or rack is secured to this assembly for supporting an accessory in suspension off the rear of the vehicle.

The other end of the support arm which is secured to the trailer hitch receiver, is adjustably securable to the receiver insert in a vertical direction. This permits vertical adjustability of the hitch assembly to accommodate different vehicles having different vertical spacing between the horizontally extending trailer hitch receiver and the rear bumper of the vehicle. In addition, for some embodiments of the present invention, this permits rigid engagement of the support arm with the vehicle rear bumper. For additional securement in this embodiment, an additional securing means, such as a bolt, is used for vertically clamping the support arm to the trailer hitch receiver insert. To accommodate for fitment in the horizontal direction, the trailer hitch receiver insert may be provided with multiple spaced pin securement passages there along so that the insert may be adjusted in the horizontal direction and there secured with a pin in a conventional manner to the trailer hitch receiver box.

In one embodiment of the vehicle hitch assembly of the present invention, the end of the support arm which is secured to the rear bumper of the vehicle is secured to the rear bumper through a rigid downwardly open cup which is dimensioned for reception of a ball hitch secured to the upper surface of the vehicle rear bumper. In a second embodiment, the end of the support arm that is connected to the rear bumper of the vehicle is connected through a rigid downwardly protruding pin extending downwardly from the arm for reception in a corresponding pin socket provided in the upper surface of the vehicle rear bumper. In yet a third embodiment of the vehicle hitch assembly of the present invention, the end of the support arm which is connected to the rear bumper of the vehicle is secured thereto through a horizontal elongated rigid support member, such as an angle iron, and this elongated support member is secured there along to the rear bumper of the vehicle. This latter embodiment, provides the greatest torque stabilizing characteristics along the width of the rear bumper so that when wide heavy loads, such as an all terrain vehicle or a motorcycle, are carried in suspension on a rack extending from the hitch receiver insert, the heavy swinging torque loads applied from one side to the other side of the vehicle are not born solely by the hitch receiver insert, but rather are uniformly distributed across the rear bumper of the vehicle.

### BRIEF DESCRIPTION OF THE DRAWINGS

Other objects and advantages appear hereinafter in the following description and claims. The accompanying drawings show, for the purpose of exemplification, without limiting the scope of the invention or appended claims, certain practical embodiments of the present invention wherein:

FIG. 1 is a perspective view of a first embodiment of the vehicle hitch assembly of the present invention with the parts thereof shown in an exploded relationship with respect to each other;

FIG. 2 is a perspective view of the vehicle hitch assembly embodiment shown in FIG. 1 with the parts thereof shown in assembled configuration;

FIG. 3 is an enlarged perspective view of the vehicle hitch assembly alone shown in FIG. 2 without securement to a vehicle rear bumper, and shown in reverse perspective;

FIG. 4 is a perspective view of the upper rigid support arm portion of the assembly shown in FIG. 3;

FIG. 5 is a perspective view of the lower trailer hitch receiver insert portion of the assembly shown in FIG. 3;

FIG. 6 is an enlarged view in side elevation of the vehicle hitch assembly of the type shown in FIG. 2 with an article or accessory support platform attached and with a portion of the rear bumper sectioned away to reveal the rear bumper hitch ball of the vehicle and securement of the hitch assembly thereto;

FIG. 7 is a view in side elevation in reduced scale of the hitch assembly configuration shown in FIG. 6 illustrating the accessory platform in full;

FIG. 8 is an enlarged perspective view illustrating a second embodiment of the vehicle hitch assembly of the present invention;

FIG. 9 is a view in side elevation of the hitch assembly embodiment shown in FIG. 8 illustrated as being attached to a trailer hitch receiver and a rear bumper, shown in cross section, of a vehicle not including a rear bumper hitch ball, such as a sport utility vehicle or van;

FIG. 10 is an exploded perspective view illustrating a third embodiment of the vehicle hitch assembly of the present invention;

FIG. 11 is a perspective view of the hitch assembly shown in FIG. 10 in assembled condition;

FIG. 12 is a perspective view showing the hitch assembly illustrated in FIG. 11 with an accessory support secured thereto for support of a load, such as a motorcycle;

FIG. 13 is a view in side elevation of the vehicle hitch assembly shown in FIG. 12; and

FIG. 14 is a view in rear elevation of the hitch assembly shown in FIG. 13.

### DETAILED DESCRIPTION OF THE PREFERRED EMBODIMENTS

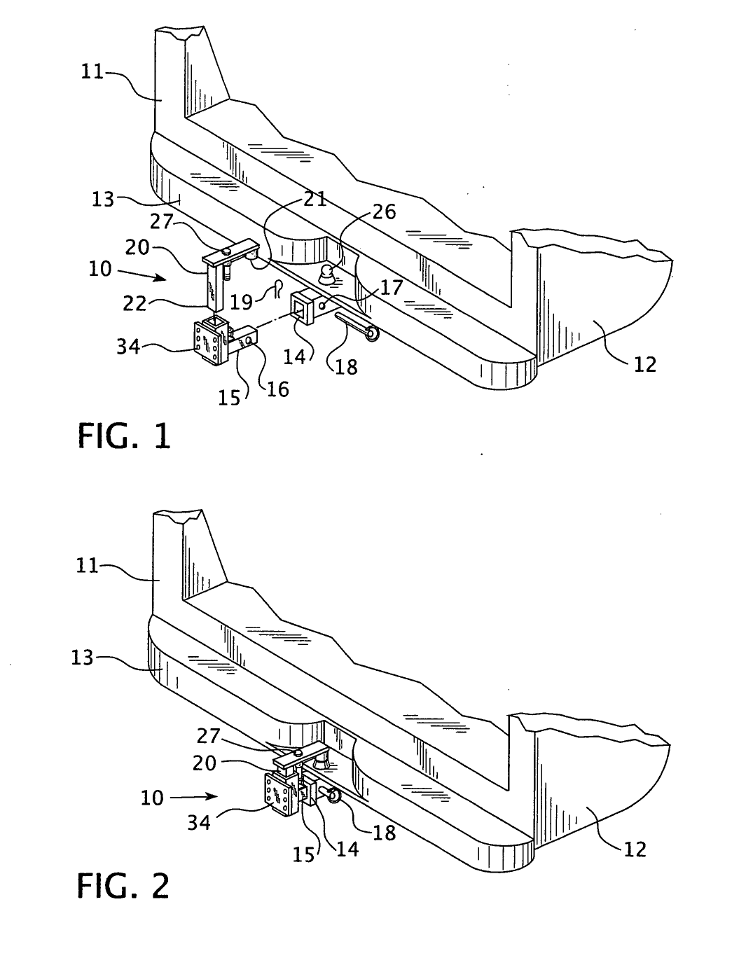

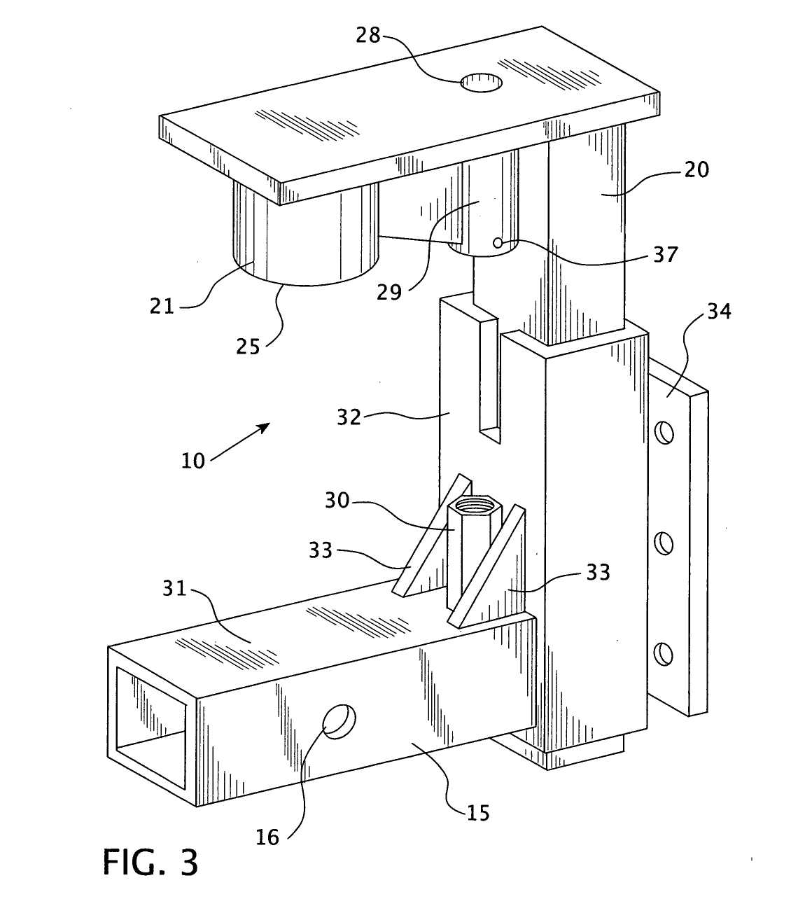

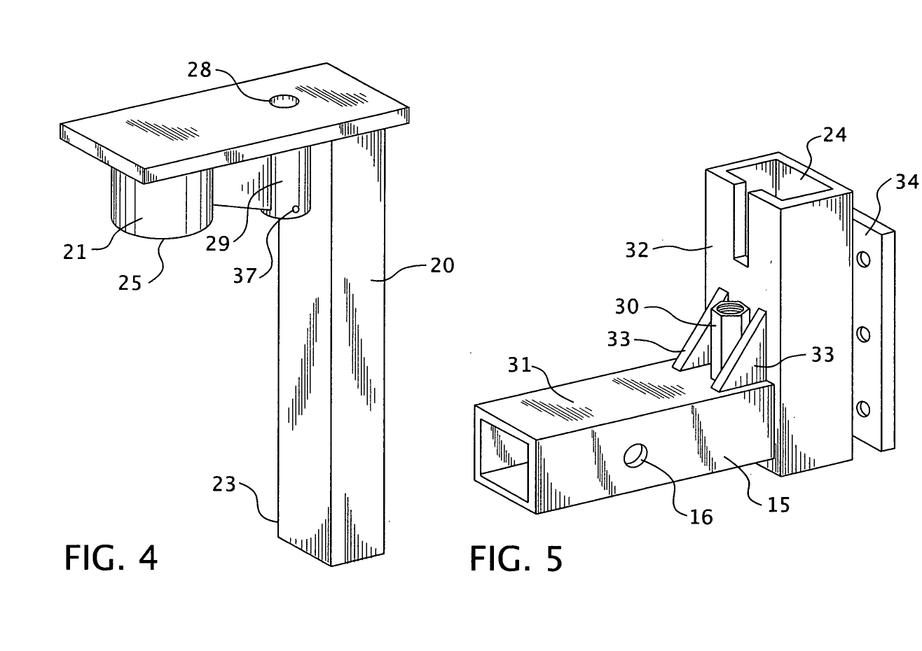

Referring first to a first embodiment of the present invention illustrated in FIGS. 1 through 6, the hitch assembly 10 of the present invention is provided for suspension support of an accessory from the rear 11 of a vehicle 12, which in this instance is a pickup truck, having a rear bumper 13 and a trailer hitch receiver 14 secured to the frame of the vehicle and positioned under the rear bumper 13. Trailer hitch receiver 14 is a conventional tubular receiver box, such as is used in Class III or IV hitches.

The vehicle hitch assembly 10 of the present invention is comprised of a horizontally extending rigid trailer hitch receiver insert 15 for insertion and retention in the vehicle trailer hitch receiver 14 in conventional fashion. The receiver hitch 15 is a tubular tongue member dimensioned to be slidably received horizontally into the tubular box of receiver 14 until the passages 16 through insert 15 are aligned with the passages 17 of receiver 14 so that securing pin 18 may be passed therethrough and secured on the other side with safety clip 19.

Vehicle hitch assembly 10 is further comprised of rigid support arm 20 having one end 21 detachably secured to the vehicle rear bumper 13, and the other end 22 thereof securable to the trailer hitch receiver insert 15.

The end 22 of support arm 20 is adjustably securable in a vertical direction to receiver insert 15. The end 22 is a square tubular member that is slidably received in the square upwardly open socket 24 of receiver insert 15. End 21 of support arm 20 is provided with a downwardly open ball hitch hood or cup 25 dimensioned for reception of hitch ball 26 provided on the rear bumper 13 of vehicle 12.

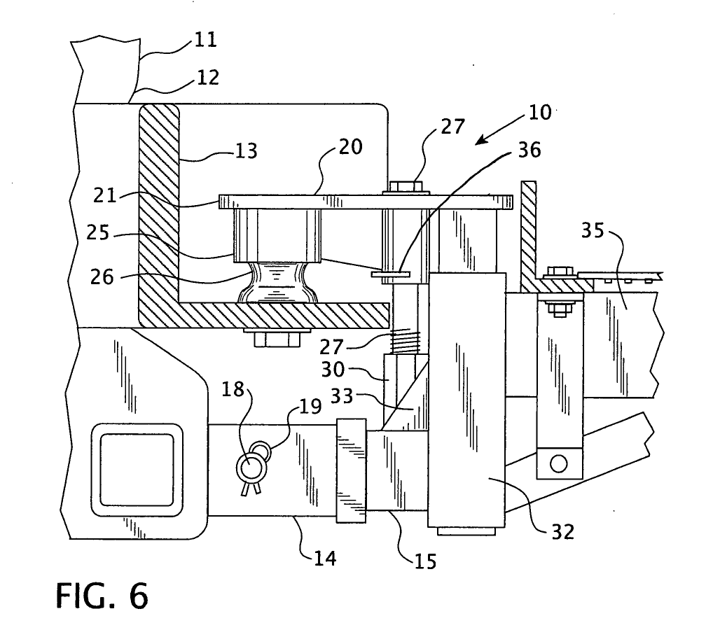

After the vehicle hitch assembly 10 is fully assembled as illustrated in FIGS. 2, 3, 6 and 7, a securing bolt 27 (FIG. 6) is passed downwardly through orifice 28 and sleeve 29 and then threadably engaged with sleeve nut 30, which is welded to the hitch receiver insert 15, for thereby securing support arm 20 to receiver insert 15 to vertically clamp them securely together in rigid engagement with the hitch ball 26 securely received within ball cup 25.

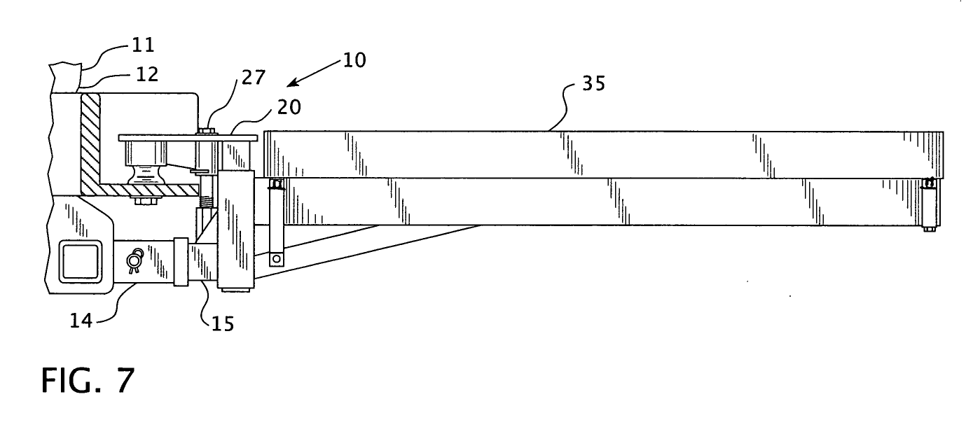

Receiver insert 15 is constructed of a horizontally extending tubular tongue member 31 which is welded to vertically extending socket tube 32 which extends upwardly at right angles. To reinforce this connection, gusset plates 33 are also welded to the inside corner of the connection between these members for additional support. A mounting plate 34 is welded to the vertical tubular member 32 for detachable securement of an accessory support, such as support platform or rack 35 as shown in FIGS. 6 and 7. However, the rack 35 in FIGS. 6 and 7 is directly secured to the vertical member 32 of insert 15 without the use of a plate 34 as by welding. Rack 35 is a support which is wide enough to support equipment, such as a lawn tractor, an all terrain vehicle, luggage, etc.

Passage 16 is provided in horizontal tongue member 31 in the horizontal direction at the appropriate position to permit adjustment of the receiver insert 15 in the horizontal direction in order to fit the different horizontal displacements of different vehicles between the rear bumper hitch ball 13 and the mouth of the trailer hitch receiver 14.

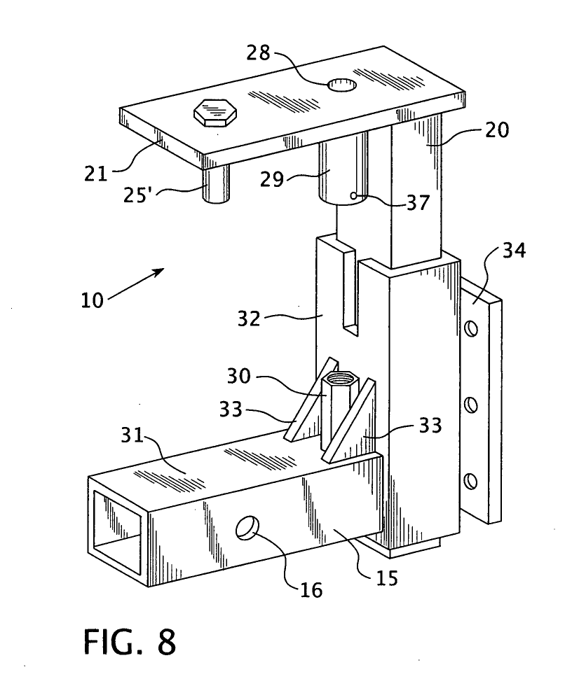

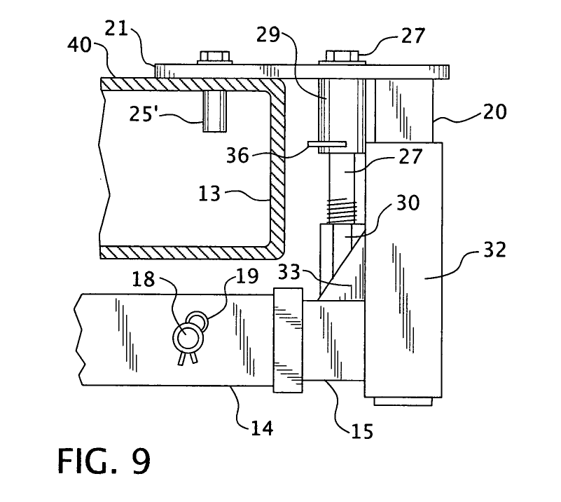

Referring next to the embodiment of the vehicle hitch assembly 10 of the present invention illustrated in FIGS. 8 and 9, like parts are designated with the same reference numerals, and the operation of the hitch assembly 10 illustrated in FIGS. 8 and 9 is identical to that of the previously illustrated embodiment with the exception that in this embodiment the assembly 10 does not require a rear bumper hitch ball 26.

In this embodiment, the hitch assembly 10 is attached to the rear of a vehicle which has a rear bumper but no rear bumper hitch ball, such as a sport utility or a van. The rear bumper 13 instead is provided with a pin bore or socket in its top 40 for downward reception therethrough ofpin 25′ which is rigidly secured to the end 21 of sport arm 20. In all other respects the hitch assembly is assembled in the same manner as the previous embodiment. In the first two embodiments of FIGS. 1 through 9, a pin 36 is also illustrated as being received through bore 37 in sleeve 29 and bolt 27 to ensure that bolt 27 will not threadably detach after securement. Pin 36 is secured with a clip (not shown) after insertion.

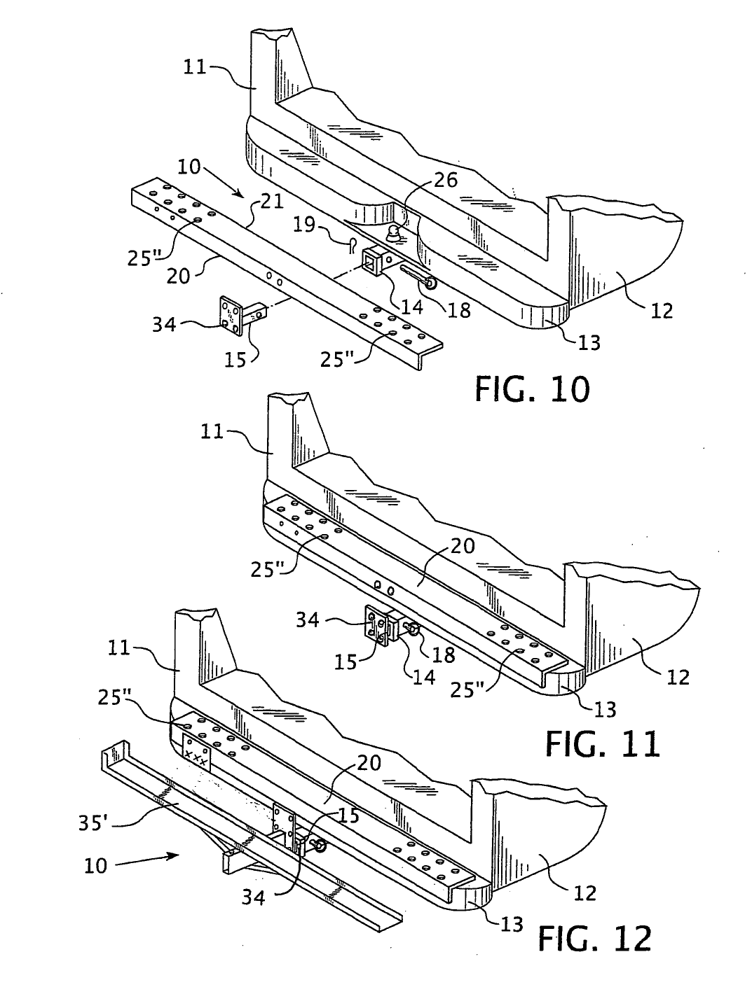

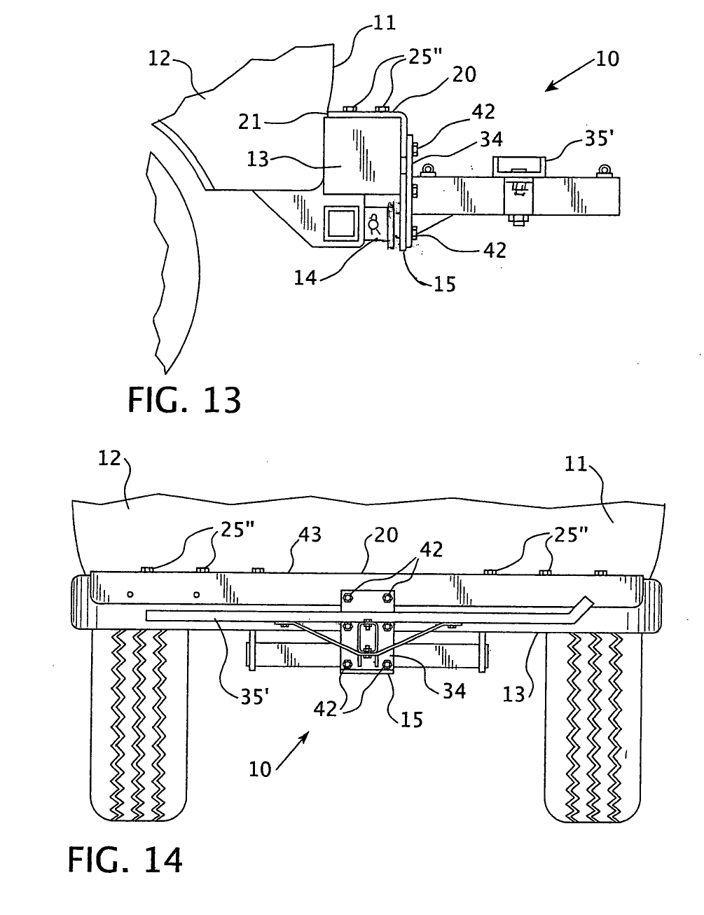

Referring next to FIGS. 10, 11, 12, 13 and 14, a third embodiment of the hitch assembly 10 of the present invention is illustrated. Again, similar components are designated with the same reference numerals. In this embodiment, the support arm 20 is comprised of a rigid elongated section of angle iron which is secured to the trailer hitch receiver insert 15 with bolts 42 and plate 34, which in this instance is made part and parcel of the insert 15.

Support arm 20 is secured along its upper surface 43 with bolts 25″. This uniformly distributes any side to side torque loads applied to accessory rack 35′ along the entire width of rear bumper 13. Thus if a heavy motorcycle is supported from accessory support 35′, side to side torque loads applied to the left and right side of the hitch assembly 10 as shown in FIG. 14 will be uniformly distributed along bumper 13 thereby permitting the suspended support carriage of long heavy loads across the back of the vehicle 12.

I claim:

1. A vehicle hitch assembly for suspension support of an accessory from the rear of a vehicle having a rear bumper and a trailer hitch receiver positioned under said bumper, said hitch assembly comprising;
a horizontally extending rigid trailer hitch receiver insert for insertion and retention in said vehicle trailer hitch receiver; and
a rigid support arm having one end detachably securable to said vehicle rear bumper and another end thereof rigidly securable to said trailer hitch receiver insert.

2. The vehicle hitch assembly of claim 1, wherein said other end of said support arm is adjustably securable in a vertical direction to said receiver insert.

3. The vehicle hitch assembly of claim 2, wherein said receiver insert is adjustably securable in a horizontal direction in said hitch receiver.

4. The vehicle hitch assembly of claim 2, including securing means for vertically clamping said another end of said support arm to said trailer hitch receiver insert.

5. The vehicle hitch assembly of claim 4, wherein said one end of said support arm is comprised of a rigid downwardly open cup dimensioned for reception of a hitch ball secured to an upper surface of said vehicle rear bumper.

6. The vehicle hitch assembly of claim 4, wherein said one end of said support arm includes a rigid downwardly extending pin for reception in a corresponding pin socket in an upper surface of said rear bumper.

7. The vehicle hitch assembly of claim 4, wherein said one end of said support arm is secured to a horizontally extending elongated rigid support member, said elongated support member having means for securement to said rear bumper.

8. The vehicle hitch assembly of claim 1, including amounting plate secured to said receiver insert for removably securing an accessory support.
